(19) United States
(12) Patent Application Publication
(10) Pub. No.: US 2014/0186808 A1
(43) Pub. Date: Jul. 3, 2014

(54) INTERACTIVE WEB-BASED PLATFORM FOR FACILITATING BIOMARKER EDUCATION AND PATIENT TREATMENT ANALYSIS

(71) Applicant: Foundation for Health Improvement and Technology, Richmond, VA (US)

(72) Inventors: Russell WARNICK, Richmond, VA (US); Bajet NOUR, Richmond, VA (US)

(73) Assignee: Foundation for Health Improvement and Technology, Richmond, VA (US)

(21) Appl. No.: 14/144,269

(22) Filed: Dec. 30, 2013

Related U.S. Application Data
(60) Provisional application No. 61/747,505, filed on Dec. 31, 2012.

(51) Int. Cl. G09B 23/28

(52) U.S. Cl. CPC G09B 23/28
USPC 434/262

(57) ABSTRACT

A method and server device that facilitates biomarker education by obtaining, with an interactive web-based platform, educational content corresponding to a plurality of laboratory biomarkers from a plurality of content providers, the educational content comprising at least medical or technical information for each of the biomarkers. The educational content is stored in a database. Web pages of the platform including at least a subset of the educational content are provided to a user in response to an interaction by the user with at least one navigation menu of the platform. Discussion of one or more of the biomarkers or the educational content is facilitated by providing a forum for obtaining comments from content providers or users and storing the comments in the database, wherein the web pages provided to the user include one or more of the comments.

### FIELD

This technology generally relates to biomarker education and analysis of biomarker testing results to identify treatment options and, more particularly, to methods and devices for providing an interactive web-based platform for disseminating educational information regarding biomarkers and including a forum for facilitating discussion of the educational information.

### BACKGROUND

Laboratory biomarkers are increasingly used to analyze disease states and risk of developing diseases for tested subjects. However, medical, technical, and commercial information regarding biomarkers is not well known or effectively made available for patients and treating physicians. Accordingly, patients are often not informed with respect to diagnostic testing procedures and results. Similarly, treating physicians often lack the knowledge and available resources required to make informed treatment decisions for their patients. Treating physicians are often unable to make treatment decisions based on the latest and/or best available research regarding laboratory biomarkers or to effectively utilize diagnostic testing results for their patients.

### SUMMARY

In an aspect, a dynamic online platform is disclosed that allows subject matter experts to post chapters and content regarding laboratory biomarkers, analysis platforms, and diseases, such as cardiovascular and cardiometabolic related subjects. The platform has blog capability to facilitate comments and suggestions to the authors as well as forums for topic discussions. The platform also incorporates an edit trail, which allows tracking of changes over time. Each chapter can include references which link to PDFs for convenient access and authors can post videos and other content media which enhance communication with readers. Additionally, banner ads can be provided to allow companies to sponsor the platform, or certain content within the platform, and to facilitate contact with manufacturers and vendors providing laboratory reagents. Thus, in a single platform, interested users can obtain complete medical, technical, and commercial information related to laboratory biomarkers.

In another aspect, a method for facilitating biomarker education is disclosed. The method includes obtaining, with an interactive web-based platform, educational content corresponding to a plurality of laboratory biomarkers from a plurality of content providers, the educational content comprising at least medical or technical information for each of the biomarkers. The educational content is stored in a database. Web pages of the platform including at least a subset of the educational content are provided to a user in response to an interaction by the user with at least one navigation menu of the platform. Facilitating discussion of one or more of the biomarkers or the educational content is facilitated by providing a forum for obtaining comments from content providers or users and storing the comments in the database, wherein the web pages provided to the user include one or more of the comments.

In yet another aspect, a method for analyzing patient health is disclosed. The method includes providing to a user of an electronic device, over a network, one or more web pages configured to present the user with a questionnaire including a plurality of questions associated with a patient's health. Answers to one or more of the plurality of questions submitted by the user of the electronic device over the network by interaction with the one or more web pages are received. Diagnostic laboratory testing results for the patient and associated with one or more laboratory biomarkers are retrieved from a storage device. One or more treatment options are determined for consideration by the patient or the patient's treating physician based on the received answers and the retrieved diagnostic laboratory testing results. One or more web pages including an indication of the one or more determined treatment options are provided to the user of the electronic device over the network.

This technology provides a number of advantages including methods and devices that more effectively provide patients and treating physicians with medical, technical, and commercial information related to laboratory biomarkers. With this invention, analytical approaches, clinical interpretations, and treatment considerations, for example, are more effectively made available and forums are provided for facilitating discussion of various topics associated with laboratory biomarkers and diagnostic testing procedures and results.

### BRIEF DESCRIPTION OF THE DRAWINGS

FIG. 1 is a block diagram of a network environment which incorporates an exemplary server device for facilitating biomarker education and analyzing patient health;

FIG. 2 is a flowchart of an exemplary method for facilitating biomarker education;

FIG. 3 is a screen shot of an exemplary portal web page of an interactive web-based platform for facilitating biomarker education and patient treatment analysis;

FIG. 4 is a screen shot of an exemplary biomarker overview and forum web page of the interactive web-based platform;

FIG. 5 is a screen shot of the exemplary biomarker overview and forum web page of the interactive web-based platform with an overlay for viewing and submitting forum topics and associated comments;

FIG. 6 is a flowchart of an exemplary method for analyzing patient health; and

FIG. 7 is a flowchart of an exemplary method for determining one or more treatment options for a patient.

### DETAILED DESCRIPTION

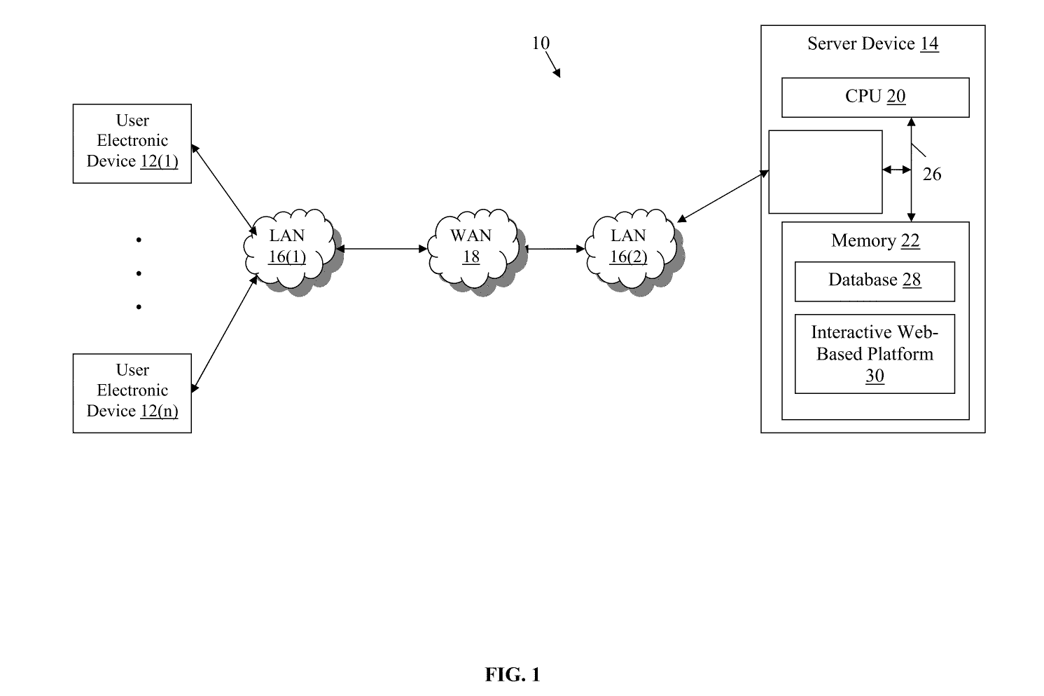

A network environment 10 with user electronic devices 12(1)-12(n) and an exemplary server device 14 coupled together by one or more communication networks, including local area networks (LANs) 16(1)-16(2) and wide area network (WAN) 18 is illustrated in FIG. 1. The exemplary environment 10 can include other numbers and types of systems, devices, components, and elements in other configurations, such as multiple numbers of each of these devices. While not shown, the environment 10 also may include additional network components, such as routers, switches and other devices, which are well known to those of ordinary skill in the art and thus will not be described here. This technology provides a number of advantages including methods and devices that more effectively facilitate biomarker education and patient treatment analysis.

The server device 14 includes a central processing unit (CPU) or processor 20, a memory 22, and a network interface device 24 which are coupled together by a bus 26 or other link, although other numbers and types of systems, devices, components, and elements in other configurations and locations can be used. The processor 20 in the server device 14 executes a program of stored instructions for one or more aspects of the present technology as described and illustrated by way of the examples herein, although other types and numbers of processing devices and configurable hardware logic could be used and the processor 20 could execute other numbers and types of programmed instructions.

The memory 22 in the server device 14 stores these programmed instructions for one or more aspects of the present technology as described and illustrated herein. However, some or all of the programmed instructions could be stored and/or executed elsewhere such as at one or more of the user electronic devices 12(1)-12(n), for example. The memory 22 of the server device 14 can store one or more databases 28 for hosting content, such as educational content for a plurality of biomarkers or forum discussions related to the educational content, as described and illustrated in detail below. Additionally, the memory 22 can store an interactive web-based platform 30 including a plurality of web pages configured to display at least some of the content stored in the database 28, as described and illustrated in detail below. Optionally, the memory 22 can further store a web application or web service configured to interface with the interactive web-based platform 30, when retrieved and executed by the user electronic devices 12(1)-12(n), to facilitate communication of the plurality of web pages and/or the content stored by the database 28 to the user electronic devices 12(1)-12(n).

A variety of different types of memory storage devices, such as a random access memory (RAM) and/or read only memory (ROM) in the server device 14 or a floppy disk, hard disk, CD ROM, DVD ROM, or other medium which is read from and written to by a magnetic, optical, or other reading and writing system that is coupled to the processor 20 in the server device 14, can be used for the memory 22. The memory 22 can also include a non-transitory computer readable medium having instructions stored thereon for one or more aspects of the present technology as described and illustrated by way of the examples herein, which when executed by the processor 20, cause the processor 20 to carry out the steps necessary to implement the methods of the examples, as described and illustrated herein.

In one example, the network interface 24 of the server device 14 operatively couples and facilitates communication between the server device 14 and the user electronic devices 12(1)-12(n) via the communications networks 16(1)-16(2) and 18, although other types and numbers of communication networks or systems with other types and numbers of connections and configurations can be used. By way of example only, the communications networks 16(1)-16(2) and 18 could use TCP/IP over Ethernet and industry-standard protocols, although other types and numbers of communication networks having their own communication protocols can also be used.

The user electronic devices 12(1)-12(n) can include a central processing unit (CPU) or processor, a memory, a network interface, and an input and/or display device interface, which are coupled together by a bus or other link, although other numbers and types of devices could be used. The user electronic devices 12(1)-12(n) may run interface applications that provide an interface to content, web applications, and/or web services hosted by the server device 14 via the communication networks 16(1)-16(2) and 18. The user electronic devices 12(1)-12(n) can include a mobile phone, smart phone, laptop, desktop, tablet, notebook, netbook, personal digital assistant or any other electronic or computing device configured to communicate over the communication networks 16(1)-16(2) and 18.

Although examples of the server device 14 are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

An exemplary method for facilitating biomarker education will now be described with reference to FIGS. 1-5. In this example, in step 200, the server device 14 obtains education content associated with laboratory biomarkers from a plurality of content providers. The content providers can be users of the user electronic devices 12(1)-12(n) and authors and subject matter experts with respect to the submitted educational content.

The content providers can request one or more submission web pages of the interactive web-based platform 30 hosted by the server device 14 using a web browser computer program, for example. The submission web page optionally allows a content provider to submit educational content such as text, graphics, images, presentations, videos, media, or any other digital media in any format. The educational content can be an overview of one or more biomarkers, analytical approaches for determining levels for one or more of the biomarkers, clinical interpretations associated with levels of one or more of the biomarkers, or treatment considerations associated with one or more of the biomarkers, for example, although any other educational content can also be submitted. The content providers can also submit reference information supporting the submitted educational content.

Optionally, the content providers can be required to register with the interactive web-based platform 30 in order to receive credentials for accessing various aspects of the platform 30, including the submission web pages, for example. An administrator of the platform 30 can receive registration requests and determine whether to associate certain access permissions with the submitted credentials, such as based on whether the credentials are submitted by a qualified content provider. The database 28 can be configured to store the registration information for users, including content providers, of the user electronic devices 12(1)-12(n) permitted access to one or more web pages of the interactive web-based platform 30.

In step 202, once obtained by the server device 14, the educational content is stored by the server device 14 in the database 28. The database 28 is optionally organized such that an association of submitted content and the content provider source of the submitted content is maintained. Additionally, the database 28 can store an association of a topic, such as a biomarker or a panel for example, and the submitted content.

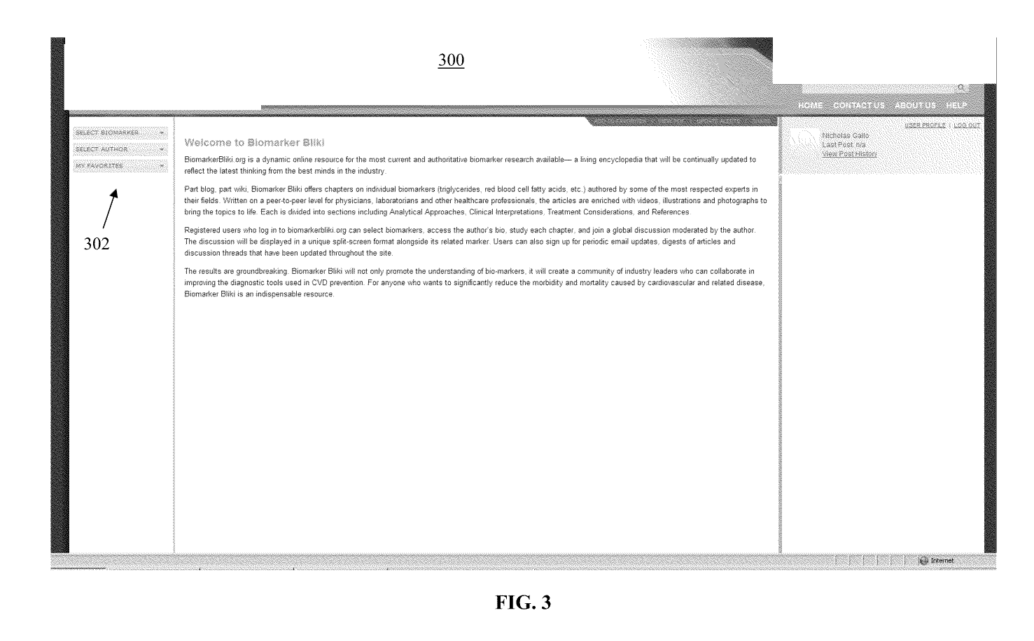

In step 204, the server device 14 receives a request, sent from a user of one of the user electronic devices 12(1)-12(n) over the communication networks 16(1)-16(2) and 18, for one or more web pages of the interactive web-based platform 30. The user can be a subject matter expert, a treating physician, a patient, or any other interested person. Referring specifically to FIG. 3, a screen shot of an exemplary portal web page 300 of the interactive web-based platform 30 is shown. The exemplary portal web page 300 is optionally sent to the user upon successful login and includes a navigational menu 302 which includes a plurality of drop-down menus, although any other menu style or navigation functionality can also be provided. In this example, the drop-down menus include a biomarker menu, an author menu, and a favorites menu which allow for user selection, although any other menus can also be provided. Accordingly, in step 204, the user of one of the user electronic devices 12(1)-12(2) can interact with the navigational menu 302 to cause a request to be sent to the server device 14 for one or more web pages of the platform 30 corresponding to the selection.

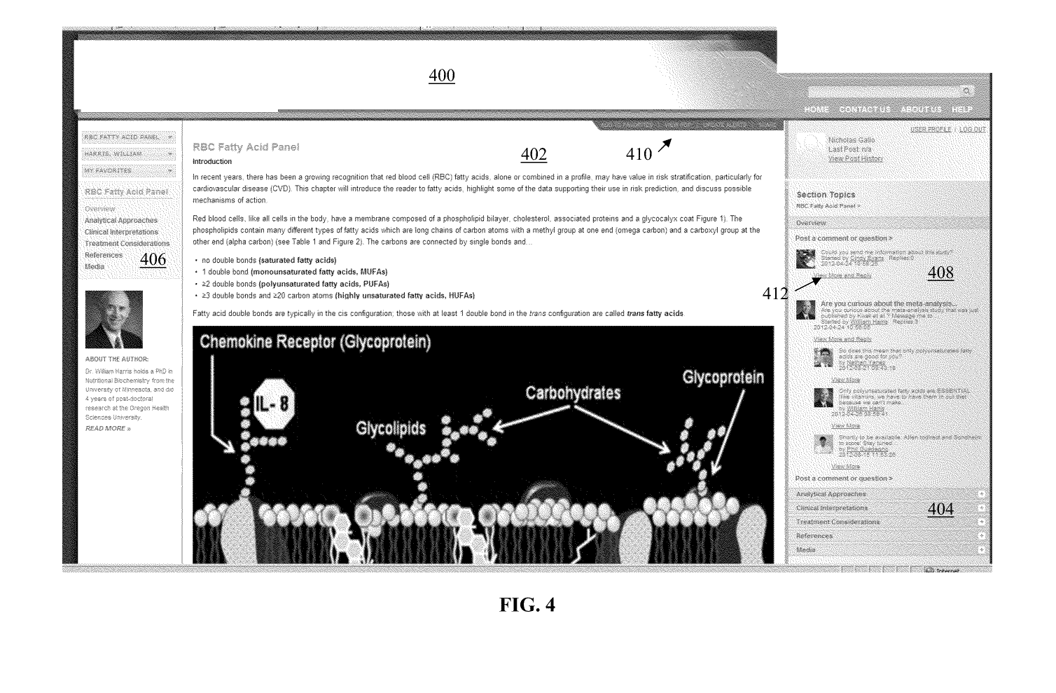

In response, in step 206, the server device 14 provides the user of the electronic device 12(1)-12(n) the one or more requested web pages corresponding to the user's selection in the navigational menu 302. Referring specifically to FIG. 4, a screen shot of an exemplary biomarker overview and forum web page 400 of the interactive web-based platform 30 is shown. The exemplary biomarker overview and forum web page 400 can be sent in response to user selection of “RBC Fatty Acid Panel” in the biomarker drop-down menu, for example. The exemplary biomarker overview and forum web page 400 includes a pane 402 which includes the educational content associated with the selected biomarker, as obtained in step 200 and stored in the database 28 in step 202.

In the exemplary biomarker overview and forum web page 400, a set of links 410 is provided including links to add the web page 400 to a favorites listing, view the pane 402 as a PDF, set an update alert, and share the educational content in the pane 402, for example, although other links and/or functionality can also be provided. Upon user interaction with the favorites link, the server device 14 can store in the database 28 an indication of the web page 400 as associated with a unique identifier, such as the login credentials, of the user of the user electronic device 12(1)-12(n). Subsequently, the favorites drop-down menu of the navigational menu 302 can include an indication of the RBC Fatty Acid biomarker overview and forum web page 400. Upon user interaction with the view as PDF link, the educational content displayed in the pane 402 can be converted to PDF format and provided by the server device 14 to the user electronic device 12(1)-12(n) in a new window, tab, pane, or overlay, for example. Upon user interaction with the update alerts link, the user can submit to the server device 14 preferences for obtaining notifications when an update to the education content of the pane 402 occurs, including the frequency and mode of notification. The server device 14 can store these preferences in the database 28 as associated with a unique identifier for the user and perform the notification automatically upon identifying an update to the content. Upon user interaction with the share link, the user can send the content to a recipient through electronic mail or by posting to a social network, for example, as is known in the art.

The pane 402 includes overview educational content by default and/or as selected in the content menu 404. The content menu 404 allows for user selection of various categories of content submitted by the content providers in step 200. Optionally, a plurality of links 406 is also provided which includes a link corresponding to each of the categories indicated in the content menu 404. Also provided within the content menu, in this example, is a forum 408 for discussion by users of the web-based interactive platform 30, such as of the educational content of the pane 402, although the forum can be provided in other locations and by other methods.

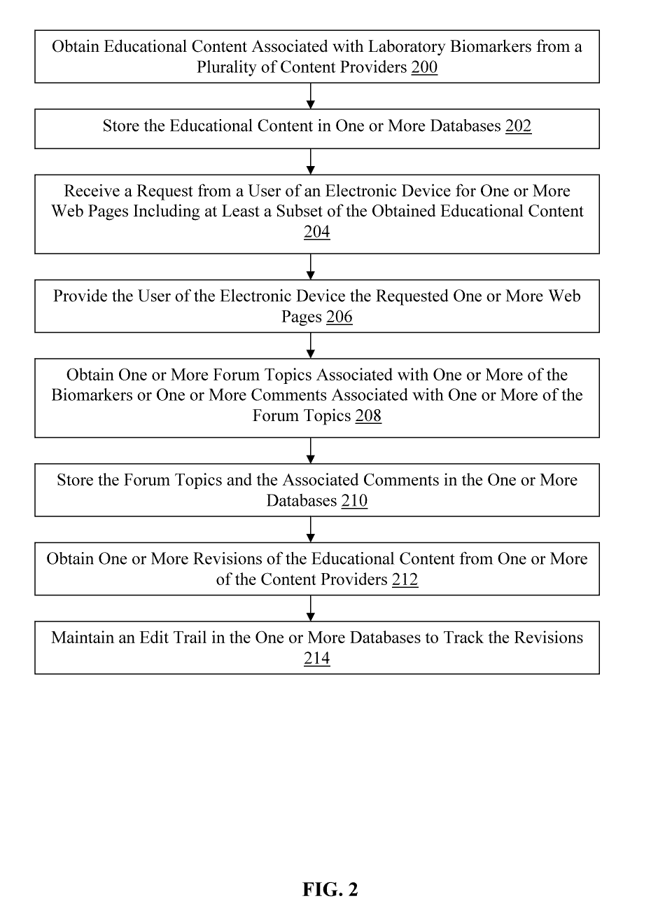

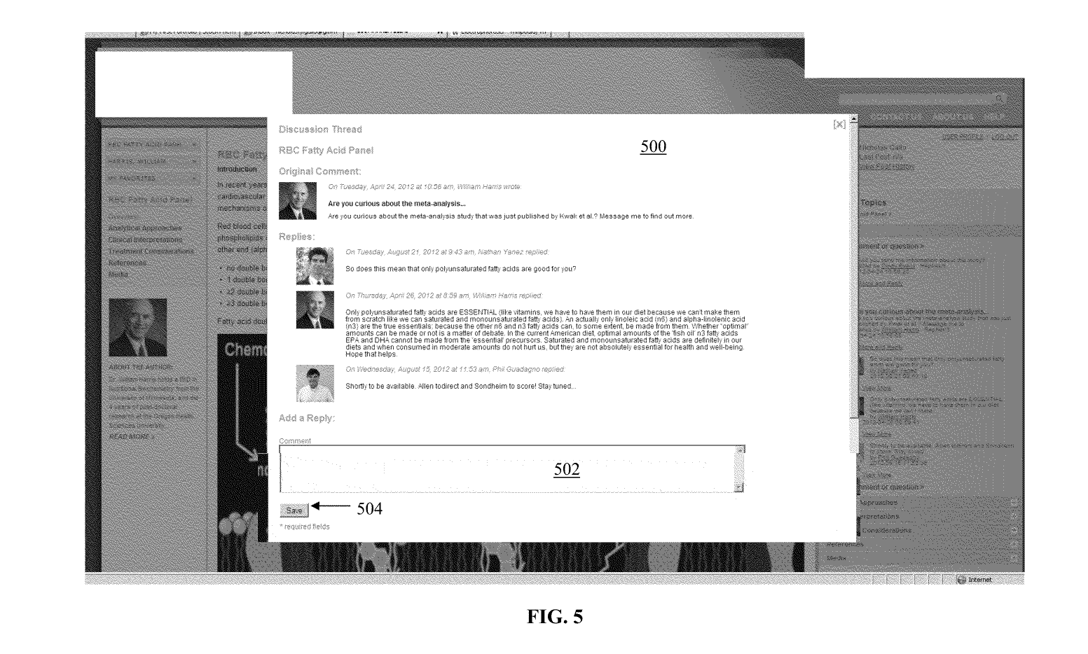

Referring back to FIG. 2, in step 208, the server device 14 obtains one or more forum topics associated with one or more of the biomarkers or one or more comments associated with one or more of the forum topics. In this example, the forum 408 includes at least one link 412 configured to facilitate user submission of content to be included in the forum 408. Referring specifically to FIG. 5, a screen shot of the exemplary biomarker overview and forum web page 400 of the interactive web-based platform 30 is shown including an overlay 500 for viewing and submitting forum topics and associated comments. The overlay 500 can be provided by the server device 14 in response to user interaction with the link 412 of the forum 408. In this example, the overlap 500 displays the forum comments or discussion thread, a submission box 502, and a save button 504. Accordingly, a user of one of the user electronic devices 12(1)-12(n) can submit a comment by entering the comment text in the submission box 502 and selecting the save button 504.

In step 210, in response to user selection of the save button 504, the comment text inserted into the submission box 502 is sent to the server device 14 and stored in the database 28. In this example, the comments are stored as corresponding to a forum topic, although the forum topics and comments can be stored in other organizational formats. Accordingly, upon receiving a subsequent request in step 204 for a web page, the web page can be provided in step 206 along with the comments of any associated forum, such as embedded in a content menu 404, as shown in the exemplary web page 400 of FIG. 4. Other methods of displaying a forum configured to facilitate discussion of the biomarkers and/or education content can also be provided.

Optionally, in step 212, the server device 14 subsequently obtains one or more revisions of the educational content from one or more of the content providers using one of the user electronic devices 12(1)-12(n). In one example, an edit link is provided proximate to any content on any of the web pages of the platform 30 submitted by the content provider, although other methods of facilitating revisions to content can also be provided. Upon interaction with the edit link, the content provider can submit revised educational content to the server device 14, which is stored in the database 28. Upon submission, the server device 14 can determine, based on any stored update alert preferences, whether any notifications regarding the revisions should be sent, as described and illustrated above.

Also optionally, in step 214, the revised educational content is compared to the previously submitted educational content and an edit trail is maintained by the server device 14 in the database 28. The edit trail tracks revisions of the educational content. Accordingly, referring back to step 206, the server device 14 can retrieve any corresponding edit trail information from the database 28, and include an indication of the historical changes made to the educational content, prior to providing any web pages of the platform 30 to the user electronic devices 12(1)-12(n). Other methods of maintaining an edit trail and/or indicating historical revisions to the educational content can also be provided.

It should be appreciated that the order in which steps 200-218 are performed can be different than the exemplary order shown in FIG. 2. Additionally, steps 200-214 can be performed in parallel for various users of the user electronic devices 12(1)-12(n). Additionally, in some examples, one or more of the web pages provided to the users further comprise one or more advertisements associated with commercial sponsors including manufacturers or suppliers of laboratory reagents associated with diagnostic testing of biomarkers. Accordingly, with this technology, interested users can advantageously obtain complete medical, technical, and commercial information related to laboratory biomarkers as well as engage in discussions through forum topics and comments regarding such content.

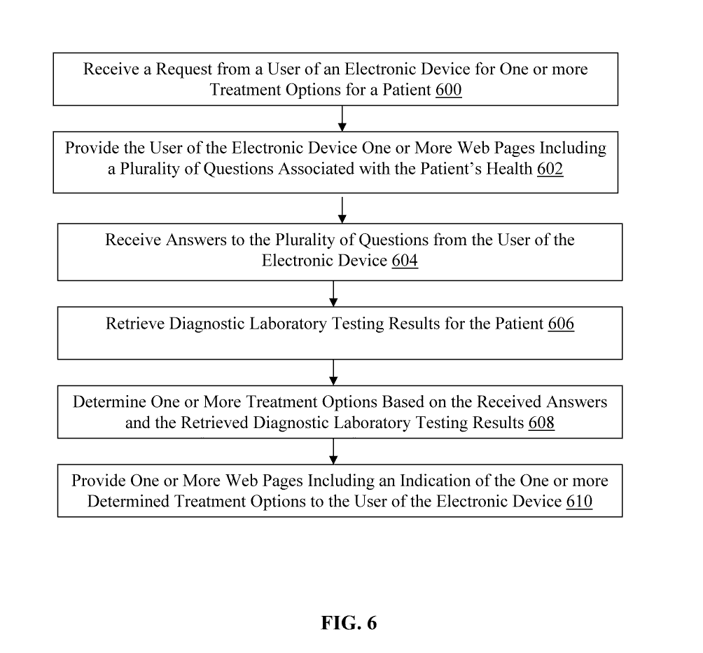

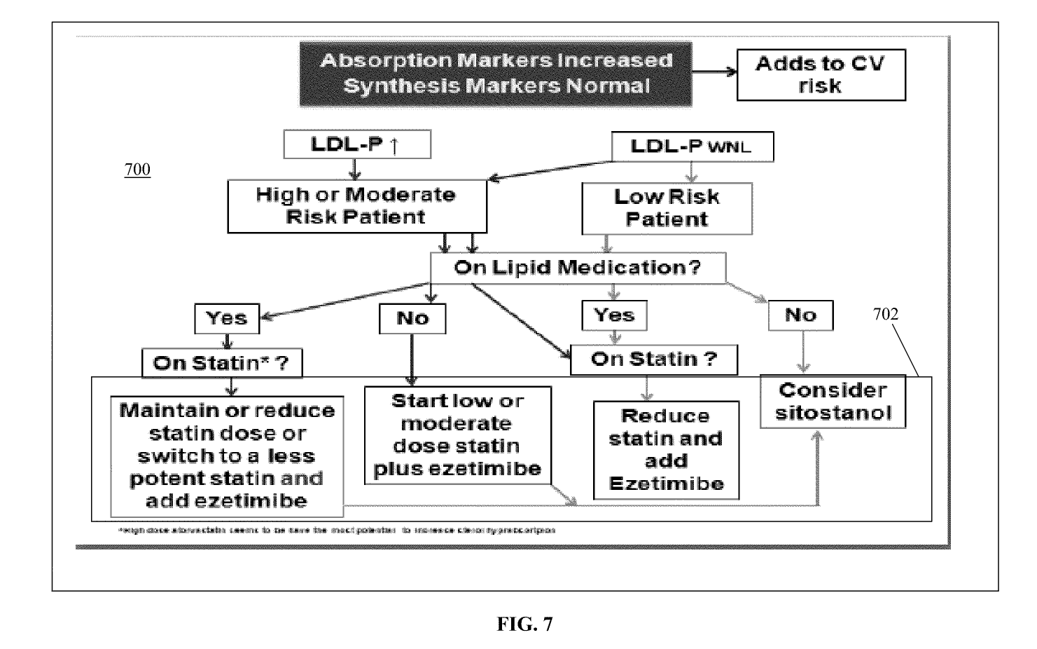

An exemplary method for analyzing patient health will now be described with reference to FIGS. 1 and 6-7. In this example, in step 600, the server device 14 receives a request from a user of one of the electronic devices 12(1)-12(n) for one or more treatment options for a patient. Referring back to FIG. 4, in this example, the request can be submitted by the user by interaction with the treatment options category of the content menu 404. In another example, the request can be initiated based on interaction with one or more web pages of the web-based interactive platform 30 accessible only by users having credentials indicating they are treating physicians. In yet other examples, the request is submitted through user interaction with a web application or web service stored in the memory 22 and executed by the processor 20 of the server device 14 or downloaded from the server device 14 and executed by the user electronic device 12(1)-12(n). The web application, web service, or downloaded computer program, such as a mobile application, or combinations thereof, can be configured to facilitate the steps of the method shown in FIG. 6 and described and illustrated below with reference to FIG. 7.

In response to receiving the request, in step 602, the server device 14 provides the user of the user electronic device 12(1)-12(n) one or more web pages including a plurality of questions associated with a patient's health. In this example, the user is a treating physician interesting in obtaining treatment options for a patient based in part on biomarker levels resulting form a diagnostic laboratory test of the patient, although the user can be any other interested person.

In this example, the treating physician user of one of the user electronic device 12(1)-12(n) submits answers to the plurality of questions which are received, in step 602, by the server device 14. The answers can include an indication of medication currently prescribed to the patient, biometric information associated with the patient, demographic information associated with the patient, or a combination thereof, although other answers and information can also be provided. The biometric information can include an indication of the physical activity, blood pressure, body composition, waist circumference, diet, nicotine use, or alcohol use of the patient, for example. The demographic information can include an indication of the gender, age, body mass index (BMI), weight, height, ethnicity, or geographic location of the patient, for example.

In step 606, the server device 14 retrieves diagnostic laboratory testing results for the patient based on a unique identifier of the patient provided by the treating physician user of one of the user electronic device 12(1)-12(n). In this example, the diagnostic laboratory testing results for the patient can be stored in the memory 22, such as in the database 28, as associated with the unique identifier of the patient. In other examples, the diagnostic laboratory testing results for the patient can be retrieved from a third party network storage device using one or more communication networks, including LAN 16(2) and WAN 18, for example.

In step 608, the server device 14 determines one or more treatment options for consideration by the patient or the patient's treating physician based on the answers received in step 604 and the diagnostic laboratory testing results retrieved in step 608. The treatment options can include increasing or decreasing a dosage level of one or more currently prescribed medications, prescribing one or more new medications, maintaining dosage levels of one or more currently prescribed medications, monitoring one or more levels of one or more biomarkers, suggesting a therapy regimen comprising one or more of drugs, supplements, or making or maintaining lifestyle choices comprising changing diet, changing exercise level, or reducing or eliminating nicotine use, or a combination thereof, although other treatment options can also be provided. In step 610, the server device 14 provides one or more web pages including an indication of the treatment options determined in step 608 to the user electronic device 12(1)-12(n).

Referring specifically to FIG. 7, a flowchart of an exemplary method for determining one or more treatment options in step 608 is shown. In this example, the LDL-P biomarker value of the patent's diagnostic laboratory report retrieved in step 608 is analyzed with respect to the patient's cardiovascular risk. Accordingly, the server device 14 in this example first determines whether the LDL-P biomarker level is increased or within normal levels. Next, the server device 14 determines whether the patient is on lipid medication and, if so, whether the patient is on a drug in the statin class, based on one or more of the answers received in step 604. Based on the determinations, the server device 14 determines one or more treatment 702 options for consideration by the patient or the patient's treating physician.

With this technology, treating physicians and patients can interface with an interactive web-based platform to obtain information regarding laboratory biomarkers submitted by subject matter experts. The platform advantageously facilitates discussion of the educational content through forums to inform interested users regarding laboratory biomarkers. Additionally, interested users, including specifically treating physicians, can interface with the platform to identify treatment options for consideration based on biomarker levels and information obtained regarding a patient.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating biomarker education, comprising:
obtaining, with an interactive web-based platform, educational content corresponding to a plurality of laboratory biomarkers from a plurality of content providers, the educational content comprising at least medical or technical information for each of the biomarkers;
storing the educational content in one or more databases;
providing one or more web pages of the platform to a user in response to an interaction by the user with at least one navigation menu of the platform, the one or more web pages including at least a subset of the educational content stored in the one or more databases; and
facilitating discussion of one or more of the plurality of biomarkers or the educational content by providing a forum for obtaining one or more comments from one or more of the content providers or one or more users and storing the comments in the one or more databases, wherein the one or more web pages provided to the user include one or more of the comments.

2. The method of claim 1, wherein the educational content further comprises one or more of an overview of one or more of the biomarkers, analytical approaches for determining levels for one or more of the biomarkers, clinical interpretations associated with levels of one or more of the biomarkers, or treatment considerations associated with one or more of the biomarkers.

3. The method of claim 1, wherein the educational content further comprises text, graphics, images, presentations, videos, other digital media, or a combination thereof.

4. The method of claim 1, further comprising facilitating discussion of one or more topics associated with one or more of the biomarkers or the educational content through one or more forums including:
obtaining one or more forum topics and one or more comments associated with one or more of the forum topics from one or more of the content providers or users;
storing the forum topics and the associated comments in the one or more databases; and
providing one or more web pages including one or more of the forum topics and one or more of the comments associated with the one or more forum topics to one or more of the users.

5. The method of claim 1, wherein the content providers are subject matter experts with respect to one or more of the biomarkers.

6. The method of claim 1, wherein the users are each associated with one of a plurality of electronic devices in network communication with the platform, the electronic devices selected from a mobile phone, smart phone, laptop, desktop, tablet, notebook, netbook, or personal digital assistant.

7. The method of claim 1, wherein one or more of the web pages provided to the user further comprise one or more advertisements associated with commercial sponsors including manufacturers or suppliers of laboratory reagents.

8. The method of claim 1, further comprising:
obtaining one or more revisions of the educational content from one of the content providers; and
maintaining an edit trail in the one or more databases, the edit trail configured to track the one or more revisions and provide an indication on one or more of the web pages provided to the user of the one or more revisions.

9. The method of claim 1, further comprising:
obtaining from one or more of the content providers, reference information supporting the educational content obtained from the one or more content providers; and
providing one or more web pages including at least a subset of the reference information to one or more of the users.

10. A method for analyzing patient health, comprising the steps of:
providing to a user of an electronic device, over a network, one or more web pages configured to present the user with a questionnaire including a plurality of questions associated with a patient's health;
receiving answers to one or more of the plurality of questions, the answers submitted by the user of the electronic device over the network by interaction with the one or more web pages;
retrieving diagnostic laboratory testing results for the patient from a storage device, the test results associated with one or more laboratory biomarkers;
determining one or more treatment options for consideration by the patient or the patient's treating physician based on the received answers and the retrieved diagnostic laboratory testing results; and
providing one or more web pages including an indication of the one or more determined treatment options to the user of the electronic device over the network.

11. The method of claim 10, wherein the answers include an indication of medication currently prescribed to the patient, biometric information associated with the patient, demographic information associated with the patient, or a combination thereof.

12. The method of claim 10, wherein one or more of the steps are facilitated by a web application executed by a server device connected to the network and configured to communicate over the network with the user's electronic device.

13. The method of claim 10, wherein one or more of the steps are facilitated by a computer program stored in a memory and executed by a processor of the user's computing device.

14. The method of claim 10, wherein the one or more treatment options comprise increasing or decreasing a dosage level of one or more currently prescribed medications, prescribing one or more new medications, maintaining dosage levels of one or more currently prescribed medications, monitoring one or more levels of one or more biomarkers, or a combination thereof.

15. The method of claim 10 wherein the biometric information comprises one or more of physical activity, blood pressure, body composition, waist circumference, diet, nicotine use, or alcohol use.

16. The method of claim 10, wherein the demographic information comprises one or more of gender, age, body mass index (BMI), weight, height, ethnicity, or geographic location.

16. The method of claim 10, wherein the electronic device is a mobile phone, smart phone, laptop, desktop, tablet, notebook, netbook, or personal digital assistant.

17. The method of claim 10, wherein the one or more treatment options comprise suggesting a therapy regimen comprising one or more of drugs, supplements, or making or maintaining lifestyle choices comprising changing diet, changing exercise level, or reducing or eliminating nicotine use.

18. The method of claim 10, wherein the storage device comprises a database maintained by a server device connected to the network and configured to store the diagnostic laboratory testing results for a plurality of patients.

19. The method of claim 10, wherein the one or more web pages provided to the user of the electronic device are associated with an interactive web-based platform comprising educational content submitted by a plurality of content providers, the educational content comprising at least medical or technical information for a plurality of biomarkers.

20. The method of claim 1, wherein the educational content further comprises one or more of an overview of one or more of the biomarkers, analytical approaches for determining levels for one or more of the biomarkers, clinical interpretations associated with levels of one or more of the biomarkers, or treatment considerations associated with one or more of the biomarkers.

21. The method of claim 20, wherein the web-based platform further comprises one or more web pages configured to facilitate discussion of one or more topics associated with one or more of the biomarkers or the educational content.

22. The method of claim 20, wherein the web-based platform further comprises one or more web pages including reference information supporting the educational content submitted by one or more of the content providers.
